(19) United States
(12) Patent Application Publication
(10) Pub. No.: US 2013/0221299 A1
(43) Pub. Date: Aug. 29, 2013

(54) Method And Apparatus For The Placement And Installation Of Wire

(71) Applicant: Frank A. DiTucci, Parsippany, NJ (US)

(72) Inventor: Frank A. DiTucci, Parsippany, NJ (US)

(21) Appl. No.: 13/406,997

(22) Filed: Feb. 28, 2012

(51) Int. Cl. H02G 1/06

(52) U.S. Cl. 254/134.3 R

(57) ABSTRACT

The invention relates to the general field of construction safety and mechanical devices. A loop is fed through a small hole in a wall and allows a user to retrieve wires or cables from behind the wall with ease. The loop is intended to expand and contract, thereby encircling a wire and allowing it to be pulled through the hole. The loop is held by a handle and is preferably made of plastic, metal or other flexible but durable material.

### BACKGROUND OF THE INVENTION

Installing electrical wiring behind walls and through floors is a frustrating and often dangerous task, even for professionals. The installation typically requires moving and placing wire through enclosed spaces that are out of reach and out of sight. Often, a wire must be fed through a hole in a wall, run behind the wall, and then somehow pulled through a second hole. After inserting a wire and dropping it behind a wall, individuals try to reach through the wall with their fingers or pliers to catch the wire and pull it through the exit hole. Alternatively, fish tape, plumb bobs and magnets have been used to locate and retrieve wire hidden behind a wall. The present invention is safer, less expensive and easier to implement than existing techniques.

To install electrical wiring behind walls or through floors, one must cut or drill holes in the wall at the locations of entry and exit. Wire must then be fed through one of the holes into the wall, where it can no longer be seen. After the wire has reached the desired location behind the wall, it must be retrieved through the exit hole. The most basic technique for retrieving the wire involves reaching a hand through the exit hole to grab the wire and pull it through. Putting a hand into a dark enclosed space potentially containing nails, pipes and other hazards may lead to injury. This approach also requires that the exit hole is large enough to fit a hand through, creating additional repair work after the wiring is finished. The present invention eliminates the need for a large hole and minimizes any danger of injury.

Another technique for electrical wiring is to use fish tape (spools of metal) to guide the wire. The fish tape is strung from the entry hole, through the wall, and out the exit hole. The fish tape is more rigid than wire, making it easier to maneuver behind walls or between floors. The wire is then attached to a hook at the end of the fish tape and pulled behind the wall in the opposite direction. This technique requires maneuvering the fish tape out of sight in an enclosed space, frustrating experience. Additionally, this technique requires the time and effort to run the fish tape through the desired pathway, then run the wire through in the opposite direction. The present invention requires less time, effort and frustration than using fish tape to install wire.

Magnetic attachments may also be used to guide a wire behind a wall. Specifically, a magnet is attached to the end of the wire and fed behind the wall through an entry hole. The installer then uses a second magnet to guide the wire behind the wall towards the exit hole. There are drawbacks to this method as well. Magnets may interfere with existing systems behind the wall such as already-installed wiring, pipes or ducts. Further, using a magnet to align the wire with the exit hole and pull it through is frustrating and difficult. The present invention reduces or eliminates these drawbacks.

### SUMMARY OF THE INVENTION

The present invention comprises a loop made of flexible material, which may be held by a handle. The loop is first inserted into a wall through a small hole. The loop may then be expanded within the cavity behind the wall by feeding additional material through the handle. The enlarged loop pushes up against the walls, or other surfaces behind the wall, and takes the shape of the cavity behind the wall. In other words, the enlarged loop encircles the interior of the area behind the wall. A wire may be fed into the cavity by, for example, dropping the wire down from above without much precision. Once the wire passes through the open loop, the loop may be constricted and pulled out through the exit hole, bringing the wire with it. This greatly reduces the difficulty in drawing the wire through the exit hole and removes the frustration of guiding the wire behind the wall.

The flexible material may be plastic, metal, any combination thereof or any other suitable material. A length of material may be used to form a loop on one side of the handle, with two open ends on the other side. Alternatively, the material may form loops on both sides of the handle. In either configuration, a stopper may be used to prevent the material from passing entirely through the handle. A motor, winch, actuator or other device may be used to feed and pull the loop through the handle.

The use of a handle is optional but preferred. The handle is preferably made of a durable material, and may comprise plastic, metal, any combination thereof or any other suitable material. The handle is preferably able to endure the force of the loop passing through as it expands and contracts. The handle may be a hollow ring, cylinder or any other shape. The handle itself may be operated independently or attached to another device or object.

By way of example and not limitation, the invention may be used to install wiring behind a wall in which the cavity is formed by two studs separated by approximately 14 inches and two walls approximately 4 inches apart. The length of the loop in this example is preferably at least 36 inches to encircle the cavity.

The invention has a wide range of applications, and is not limited to installing wire behind vertical walls. The device may be used to install wire underneath floors, above ceilings or behind any other similar surface. The device may be used with spaces which are not entirely enclosed but nonetheless difficult to reach and see (e.g., behind a desk or large filing cabinet). Accordingly, the space behind the wall does not need to be entirely closed, and in fact may be open. The looped material may be fed through multiple walls or surfaces without disrupting its operation, and one or more wires may be retrieved at a single time. The invention may be used despite foreign objects behind the wall such as other wires, pipes, ducts, studs, beams, etc.

The present invention is not limited to the installation of wiring, and may be used in other applications. For example, the present invention may be embodied in a medical device or used in medical procedures. As another example, the present invention may be embodied in a manufacturing device or used in manufacturing processes or procedures. The invention is not limited to the installation of wire, and may be used to install cable, cord, string, rope, tubing or other similar items.

### BRIEF DESCRIPTION OF THE DRAWINGS

FIG. 1 illustrates the general construction of a loop and handle.

FIGS. 2A and 2B illustrate the initial expansion of the loop within an enclosed space.

FIGS. 3A and 3B illustrate a wire dropped into the enclosed area of the loop.

FIGS. 4A and 4B illustrate the constriction of the loop around the wire.

FIG. 5 illustrates the wire being withdrawn through the hole.

FIG. 6 illustrates the wire withdrawn completely through the hole after the looped device has been removed.

Other objects, features, and characteristics of the present invention, as well as methods of operation and functions of the related elements of the structure, and the combination of parts, will become more apparent upon consideration of the following detailed description with reference to the accompanying drawings, all of which form part of this specification.

### DETAILED DESCRIPTION OF THE PREFERRED EMBODIMENT

A detailed illustrative embodiment of the present invention is disclosed herein. However, techniques, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention.

None of the terms used herein, including “wire”, “wall”, “handle”, “open ends”, and “holes” are meant to limit the application of the invention. The terms are used to illustrate the preferred embodiment and are not intended to limit the scope of the invention. Similarly, the use of these terms is not meant to limit the scope or application of the invention, as the invention is versatile and can be utilized in many applications, as will be apparent. The following presents a detailed description of the preferred embodiment of the present invention with reference to the figures.

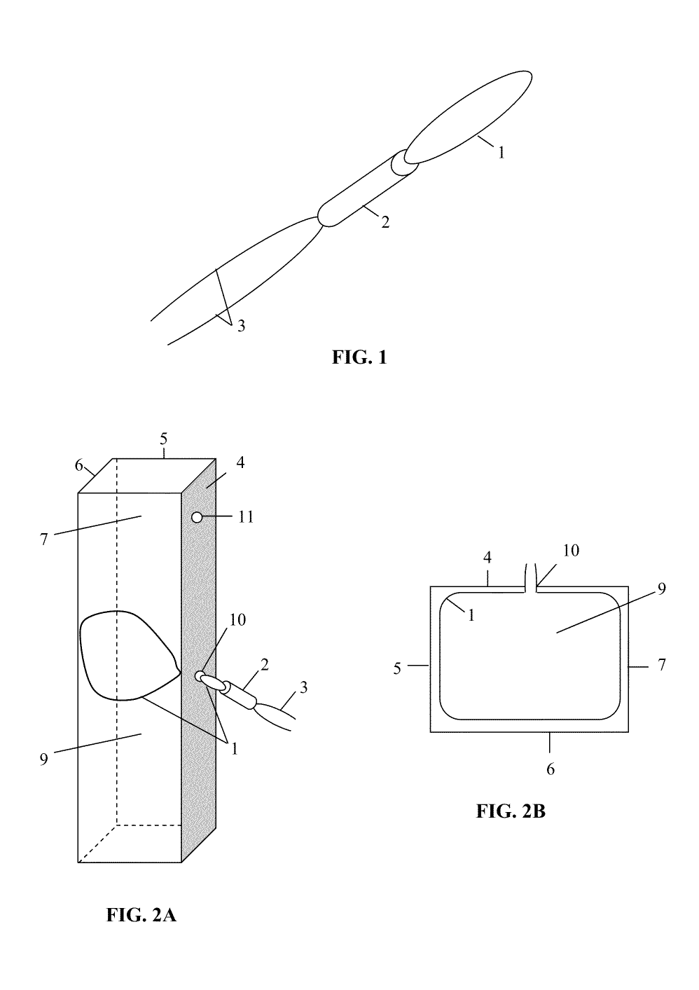

Referring to FIG. 1, a length of flexible material passes through handle 2 and forms loop 1 and open ends 3. Loop 1 may be inserted into a small hole in a wall. By pushing material from open ends 3 through handle 2, loop 1 is expanded. By pulling on open ends 3, loop 1 is retracted through handle 2, yielding a smaller loop.

Referring to FIG. 2A, walls 4, 5, 6 and 7 form enclosed space 9. Holes 10 and 11 are cut into wall 4 with the intention of installing a wire between holes 10 and 11 on the backside of wall 4. A user first inserts loop 1 through hole 10. Loop 1 is expanded by pushing open ends 3 through handle 2. Loop 1 then expands behind wall 4 within space 9. Preferably, loop 1 is sufficiently flexible to take the shape of enclosed space 9 and sturdy enough to maintain this shape. FIG. 2B represents the birds-eye view of the enclosed space 9. The expansion of loop 1 is limited by the interior of walls 4, 5, 6 and 7, causing loop 1 to substantially take the shape of enclosed space 9. Loop 1 is shown encircling the majority of enclosed space 9.

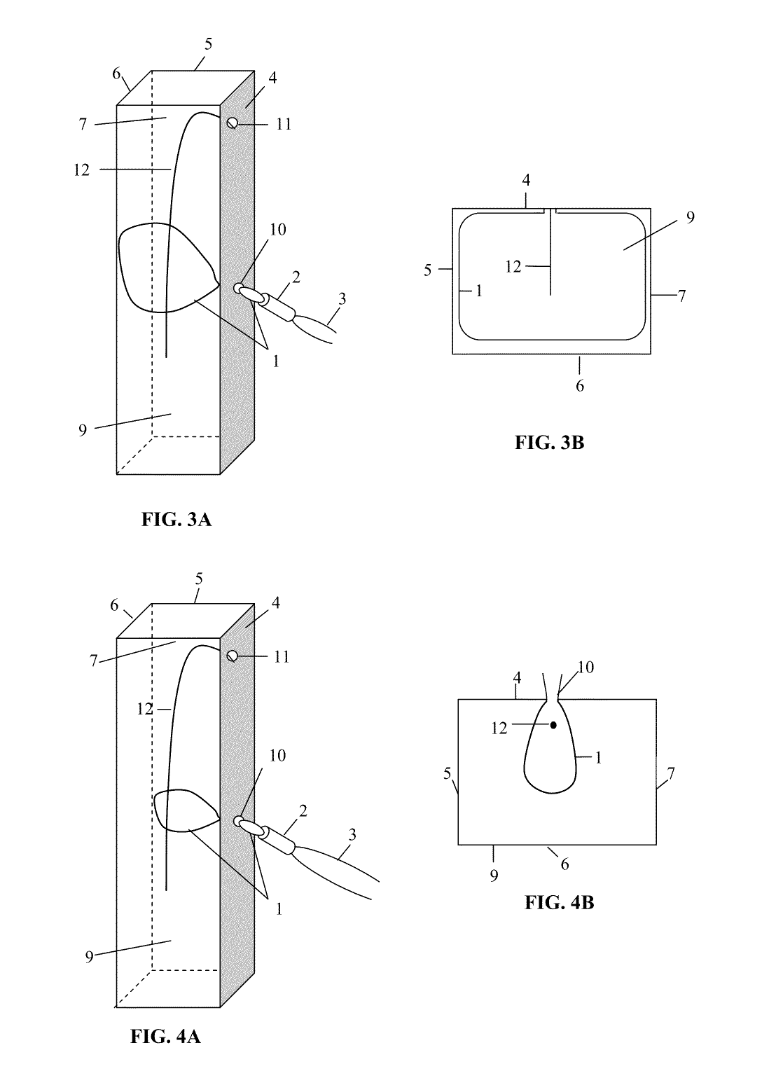

In FIGS. 3A and 3B, a wire 12 is fed through hole 11 and into space 9. FIG. 3B depicts a birds-eye view of enclosed space 9. Because loop 1 encircles the majority of enclosed space 9, wire 12 will fall down into the area encircled by loop 1. Significantly, wire 12 does not need to be precisely guided through a specific route in enclosed space 9. Rather, wire 12 may be freely fed through hole 11 and dropped down towards loop 1. Once wire 12 is within the area encircled by loop 1, the loop may be constricted by pulling on open ends 3.

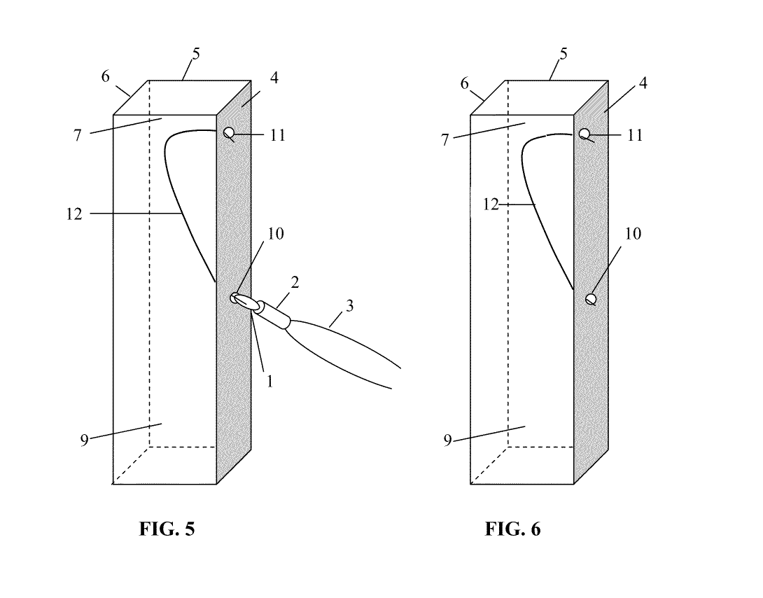

As illustrated in FIGS. 4A and 4B, open ends 3 are pulled, causing loop 1 to contract around wire 12. FIG. 5 illustrates the removal of wire 12 from enclosed space 9 through hole 10. Handle 2 and open ends 3 are pulled back away from wall 4, drawing loop 1 through hole 10. Because loop 1 has constricted on wire 12, wire 12 is also drawn through hole 10. Wire 12 now extends from holes 10 and 11, and is installed behind wall 4. Holes 10 and 11 may now be sealed around the protruding ends of wire 12. FIG. 6 illustrates the completed installation of wire 12.

It should be understood that gravity is not necessary for the operation of the invention. A sufficiently strong wire may be fed behind a wall upwards or at any angle, and may still be captured by the loop of the present invention. Alternatively, a device may be used to draw the wire upwards or at any angle towards the loop without affecting the operation of the present invention.

In another embodiment, the invention may be used with a wire that is difficult to pull through a hole because of its size or composition. A smaller and more flexible string is attached to the end of the wire, fed behind the wall and through a loop, and then drawn through the hole as described above. By pulling on the free end of the string, the wire may be drawn through the exit hole.

In another embodiment, the handle may comprise a device for locking the length of the loop. The device may be a clip, fastener, thumbscrew or other suitable device.

In yet another embodiment, the material of the loop may be bent, molded or otherwise caused to have corners or bends at predetermined intervals. The corners of the loop are intended to coincide with the corners of the cavity formed by adjoining walls. In this embodiment, the corners of the loop conform to the corners formed by the walls, allowing the loop to more substantially or completely encircle the cavity.

While the present invention has been described with reference to the preferred embodiment, which has been set forth in considerable detail for the purposes of making a complete disclosure of the invention, the preferred embodiment is merely exemplary and is not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention. It should be appreciated that the present invention is capable of being embodied in other forms without departing from its essential characteristics.

1. A method for retrieving wire, comprising:
inserting an expandable loop of material through a hole in a wall;
expanding the expandable loop behind the wall;
feeding a wire through the expandable loop behind the wall; and
withdrawing the expandable loop of material and the wire from the wall through the hole.

2. The method of claim 1, wherein the loop of material comprises plastic.

3. The method of claim 1, wherein the loop of material comprises metal.

4. An apparatus comprising:
a handle; and
an expandable loop of flexible material extending from the handle, wherein the expandable loop is configured to be expanded within a cavity and retracted.

5. The apparatus of claim 4, wherein the looped flexible material comprises plastic.

6. The apparatus of claim 4, wherein the looped flexible material comprises metal.

7. The apparatus of claim 4, wherein the handle comprises plastic.

8. The apparatus of claim 4, wherein the handle comprises metal.

9. The apparatus of claim 4, wherein the handle comprises a hollow cylinder.

10. The apparatus of claim 9, wherein the loop of flexible material passes through the handle.

11. The apparatus of claim 10, wherein the loop of flexible material comprises a length of flexible material extending from a first side of the handle and forming a loop; and
wherein the length of flexible material comprises two ends extending from a second side of the handle.

12. The apparatus of claim 4, wherein the expandable loop of flexible material is configured to substantially encircle the interior of the cavity.

13. The method of claim 1, further comprising: expanding the expandable loop to substantially encircle a cavity behind the wall.

14. The method of claim 1, further comprising: contracting the expandable loop around the wire.
